(19) United States
(12) Patent Application Publication
(10) Pub. No.: US 2026/0090678 A1
(43) Pub. Date: Apr. 2, 2026

(54) Device for Infusing Food

(71) Applicants: Reinhold Edward Bauman, Edson (CA); Emma Fern Bauman, Edson (CA)

(72) Inventors: Reinhold Edward Bauman, Edson (CA); Emma Fern Bauman, Edson (CA)

(21) Appl. No.: 18/903,383

(22) Filed: Oct. 1, 2024

(51) Int. Cl. A47J 43/00; A23L 19/00

(52) U.S. Cl. CPC A47J 43/00; A23L 19/03

(57) ABSTRACT

A device for infusing food includes a receptacle attachment element, such as a cork; a vent assembly; a flow valve; and an infuser conduit. The receptacle attachment element attaches to an opening of a receptacle that contains a substance to be infused into a food item, such as a watermelon, and the infuser conduit is in fluid communication with the receptacle attachment element to receive the substance therethrough. The infuser conduit is able to pierce through the food item and insert thereinto to infuse the substance into the food item. In some examples, the substance is flavoring and/or alcohol, such as wine or spirits.

### CROSS-REFERENCE TO RELATED APPLICATION

The present application is related to and claims priority to U.S. Provisional Patent Application No. 63/591,768 filed Oct. 20, 2023, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The present invention relates generally to the field of food treatment of existing art and more specifically relates to a device for infusing food items, such as fruit, with flavorings, alcohol and/or other substances.

The popularity of infusing food items lies in the ability to customize flavors and create a refreshing, alcoholic or non-alcoholic treat. Infused watermelons are often enjoyed during social gatherings, barbecues, or parties, offering a playful and novel twist on the popular fruit. The infusion process allows for creativity by experimenting with various flavor combinations, resulting in a diverse range of flavor profiles to suit different preferences.

The process of infusing a food item, such as a watermelon, with flavoring and/or alcohol usually begins by cutting a hole in the watermelon, creating an opening to introduce the desired flavoring or alcohol. Common methods of introducing the desired flavoring or alcohol involve using syringes, injectors, or soaking the fruit in a flavored liquid or alcohol mixture. The watermelon absorbs the flavors over time, enhancing its taste and creating a unique, infused beverage or snack.

However, there are challenges with this current process. Cutting a hole in the watermelon can be messy and imprecise, making it difficult to achieve consistent flavor distribution. Getting the flavoring or alcohol into the fruit can also be labor-intensive and messy, especially when using tools like syringes or current injectors in the art as the flavoring or alcohol must be transferred to the syringe/injector first. Further, the infusion process can require significant time, as the flavors need time to penetrate the fruit thoroughly, particularly when soaking the fruit. Accordingly, there is a need for a solution that is convenient, precise, and minimizes mess during the infusion process.

### SUMMARY OF THE INVENTION

In view of the foregoing disadvantages inherent in the known food flavor/alcohol infusion art, the present disclosure provides a novel device for infusing food. The general purpose of the present disclosure, which will be described subsequently in greater detail, is to provide a means of effectively and easily infusing a food item (such as a watermelon) with a substance, such as a flavoring or an alcohol, in a considerably cleaner and less time consuming manner than conventional methods used in the art.

A device for infusing a food item with a substance is disclosed herein. According to one or more embodiments of the present disclosure, the device includes an infuser conduit, a receptacle attachment element and a flow valve. The infuser conduit may include a first end, a second end opposite the first end, a length therebetween and at least one infusion hole disposed on the length. The first end may be configured to pierce the food item for insertion of the at least one infusion hole into the food item. The receptacle attachment element may include a central bore disposed from a top to a bottom thereof through which the second end of the infuser conduit extends. The receptacle attachment element may be configured to attach to an opening of a receptacle containing the substance therein, thereby placing the infuser conduit in fluid communication therewith (and enabling the substance to be infused into the food item via the at least one infusion hole). The flow valve may be attached along the length of the infuser conduit below the receptacle attachment element and configured to control flow of the substance through the infuser conduit.

According to another embodiment, a device for infusing a watermelon with a substance may include an infuser conduit, a receptacle attachment element, a flow valve and a vent assembly. The infuser conduit may include a first end opposite a second end, a length therebetween, and a plurality of infusion holes disposed along the length; the first end configured to pierce the watermelon for insertion of the plurality of infusion holes into the watermelon. The receptacle attachment element may include a central bore disposed from a top to a bottom thereof through which the second end of the infuser conduit extends. Further, the receptacle attachment element may be configured to attach to an opening of a receptacle containing the substance, thereby placing the infuser conduit in fluid communication therewith (and enabling the substance to be infused into the watermelon via the plurality of infusion holes). The flow valve may be attached along the length of the infuser conduit below the receptacle attachment element and configured to control flow of the substance through the infuser conduit.

The vent assembly may include an air vent port and an air vent line attached at an air vent line first end to the air vent port and extending through the receptacle attachment element. The air vent line configured for insertion into the receptacle when the receptacle attachment element is attached to the receptacle.

According to another embodiment, a method of infusing a food item with a substance is disclosed herein. The method may comprise the steps of: providing the device as above; with the flow valve in a closed position, attaching the receptacle attachment element to an opening of a receptacle containing the substance; piercing a first end of the infuser conduit through the food item; inserting the length of the infuser conduit into the food item; and placing the flow valve into an open position, thereby enabling the substance to flow from the receptacle, through the infuser conduit and out through the plurality of infusion holes to infuse the food item with the substance.

For purposes of summarizing the invention, certain aspects, advantages, and novel features of the invention have been described herein. It is to be understood that not necessarily all such advantages can be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF FIGURES

The figures which accompany the written portion of this specification illustrate embodiments and methods of use for the present disclosure, a device for infusing food, constructed and operative according to the teachings of the present disclosure.

FIG. 1 is a perspective view of a device being used to infuse a food item with a substance from a receptacle, according to an embodiment of the disclosure.

FIG. 2 is a front view of the device being used to infuse the food item with the substance, the substance being dispensed through an infuser conduit inserted into the food item, according to an embodiment of the disclosure.

FIG. 3 is a perspective view of the device including the infuser conduit, a receptacle attachment element, a flow valve and a vent assembly, according to an embodiment of the present disclosure.

FIG. 4 is a perspective view of the device removed from the receptacle, according to an embodiment of the present disclosure.

FIG. 5 is an exploded view of the device, according to an embodiment of the present disclosure.

FIG. 6 is a perspective view of the device, according to another embodiment of the present disclosure.

FIG. 7 is a flow diagram illustrating a method of infusing a food item with a substance, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a device for infusing a food item with a substance. Generally, the device for infusing a food item with a substance enables the easy infusing of food items such as fruits and vegetables, and more particularly watermelons, with substances such as flavorings and/or alcohol. The device enables infusion of food items without necessitating a hole to be cut into the food item first. Further, the device prevents spills of the substance being introduced into the food item by attaching directly to the receptacle, or bottle, containing the substance (such as a wine bottle). Accordingly, the device provides a minimal mess solution to infusing food items.

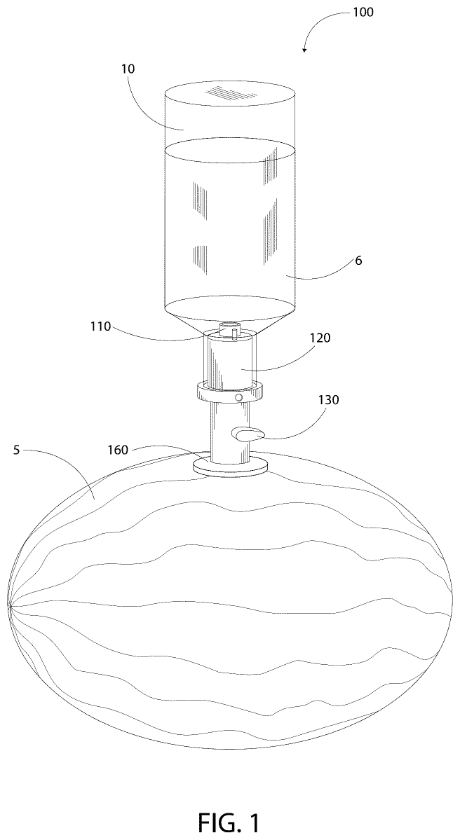

Referring now more specifically to the drawings by numerals of reference, there is shown in FIGS. 1-6, various views of a device 100 for infusing a food item 5 with a substance 6.

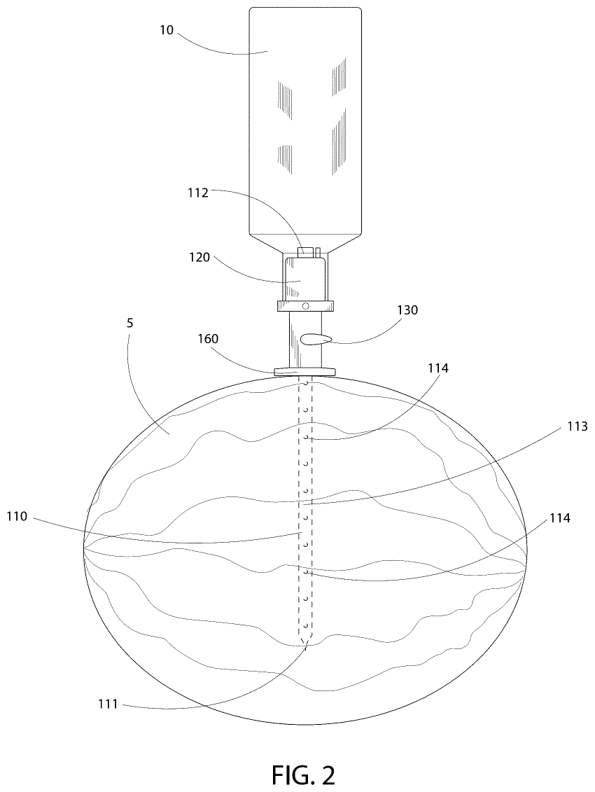

Referring first to FIGS. 1-2, illustrating a perspective view (FIG. 1) and a front view (FIG. 2) of the device 100 being used to infuse the food item 5 with the substance 6. As shown here, and as discussed above, the food item 5 may preferably be a watermelon. However, it should be appreciated that the device 100 is not limited to use with a watermelon. The substance 6 may be an alcohol, a favoring substance 6, or mixtures thereof. Examples of substances contemplated for use with the device 100 include (but are not limited to) wine and spirits such as (again, not limited to) whiskey, vodka, gin, or the like.

As shown here, the device 100 may include an infuser conduit 110, a receptacle attachment element 120 and a flow valve 130. The receptacle attachment element 120 may be configured to attach to a receptacle 10 containing the substance 6 to be infused into the food item 5. In some embodiments, the receptacle attachment element 120 may be configured to attach to an existing receptacle 10. For example, the receptacle attachment element 120 may be configured to attach to a wine bottle, a vodka bottle, a whiskey bottle, or the like. In other embodiments, the receptacle 10 may be provided as an element of the device 100 and designed for specific attachment to the receptacle attachment element 120.

As demonstrated in FIG. 2, the infuser conduit 110 may include a first end 111 for piercing the food item 5 and a plurality of infusion holes 114 disposed along a substantial portion of the length 113 of the infuser conduit 110 to maximize the amount of the substance 6 that is infused into the food item 5. The infuser conduit 110 may thus be of a size to enable insertion of the substantial portion of the length 113 into the food item 5. As such, when the length 113 of the infuser conduit 110 is inserted into the food item 5 and the substance 6 flows through the infuser conduit 110, it exits out of the plurality of infusion holes 114 and into the food item 5 to infuse the food item 5.

As above and as shown in FIGS. 1-2, the food item 5 may be a watermelon. As such, it is contemplated that the first end 111 of the infuser conduit 110 be of a sharpness, and the infuser conduit 110 itself be of a thickness and sturdiness, to enable the infuser conduit 110 to pierce through the skin of the watermelon. However, a person of ordinary skill in the art should appreciate that this sharp, thick and sturdy construction should be balanced with a construction that prevents splitting of or other damage to the watermelon (or other food item 5) when the infuser conduit 110 is inserted therein.

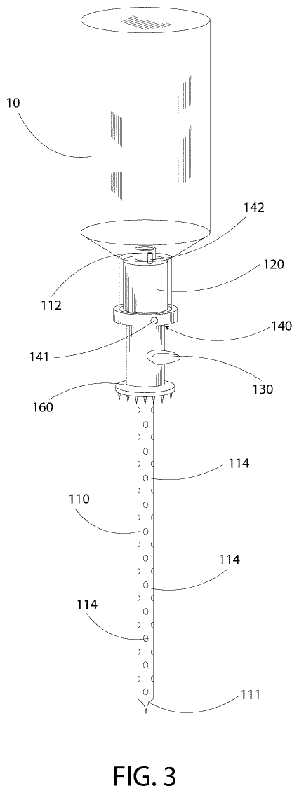

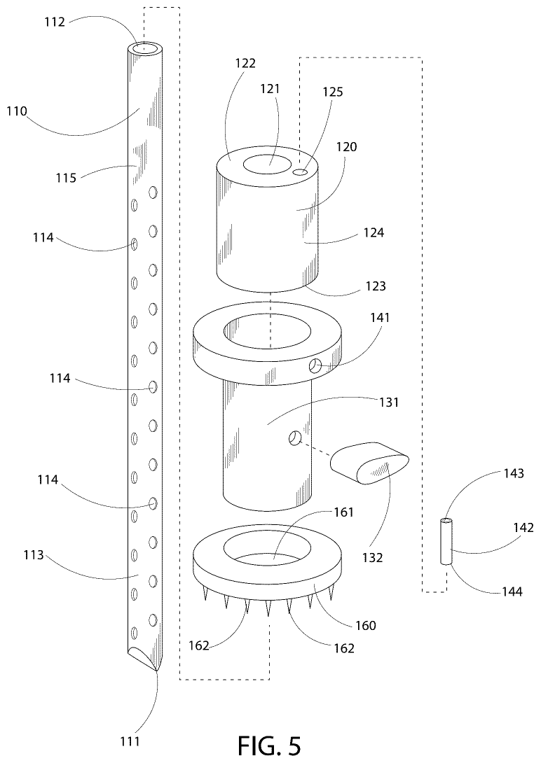

Referring now to FIGS. 3-5, demonstrating various views of the device 100 for infusing the food item 5, according to one or more embodiments of the present disclosure. As shown here, the infuser conduit 110 may include the first end 111, a second end 112 opposite the first end 111 and the length 113 therebetween. In some embodiments, as shown here, the infuser conduit 110 may include a tubular, or cylindrical configuration having an outer cylindrical wall 115 defining an interior. As shown, the first end 111 may be sharpened, pointed, or otherwise adapted to pierce through the food item 5, enabling the infuser conduit 110 to be inserted into the food item 5. For example, in some embodiments, the first end 111 may be pointed, terminating with a singular sharp point. In other embodiments, the first end 111 may include a flat edged tip that enables the first end 111 to slice through the food item 5. As above, the length 113 of the infuser conduit 110 may include the plurality of infusion holes 114 therein. In particular, as shown best in FIG. 5, the plurality of infusion holes 114 may be arranged in columns around the cylindrical wall 115.

The receptacle attachment element 120 may include a central bore 121 disposed from a top 122 to a bottom 123 thereof, through which the second end 112 of the infuser conduit 110 extends. As such, when the receptacle attachment element 120 is attached to the receptacle 10, the receptacle 10 and the substance 6 contained therewithin are placed in fluid communication with the infuser conduit 110, allowing the substance 6 to be directed through the infuser conduit 110 and into the food item 5 (through the plurality of infusion holes 114). The flow of the substance 6 may be aided by gravity. In particular, as shown in FIGS. 1-3, the receptacle 10 may be oriented in an inverted position and the infuser conduit 110 vertical, thereby allowing the substance 6 to flow from the receptacle 10, through the infuser conduit 110 and into the food item 5 via gravity.

As demonstrated in FIG. 3 particularly, the receptacle attachment element 120 may insert into the opening of the receptacle 10. As such, the receptacle attachment element 120 may include a size and shape able to insert into the opening of the receptacle 10. Particularly, the receptacle attachment element 120 may be sized to seal the opening of the receptacle 10 such that the substance 6 is only able to flow through the central bore 121 (shown in FIG. 5) located in the receptacle attachment element 120.

In some embodiments, the receptacle attachment element 120 may be a cork. The cork may include a tubular or cylindrical outer wall 124 configured to press against an inner circumference of the opening of the receptacle 10 to seal the opening. The cork can be a conventional cork made from cork material, or can be made from other materials, such as rubber, silicone, or the like.

As shown in these figures, the flow valve 130 may be attached along the length 113 of the infuser conduit 110, below the receptacle attachment element 120. The flow valve 130 may include a valve body 131, a valve seat (not shown), a closure mechanism in selective communication with the valve seat (not shown) and a valve lever 132 to operate the closure mechanism.

The flow valve 130 is configured to control flow of the substance 6 through the infuser conduit 110. Particularly, the flow valve 130 may admit flow of the substance 6 through the infuser conduit 110 (when in an open position), or completely stop the flow of the substance 6 through the infuser conduit 110 (when in a closed position). Further, in some embodiments, the flow valve 130 may control a rate of the flow or amount of the substance 6 admitted through the infuser conduit 110. For example, if the user wishes to slowly infuse the food item 5, they may open the flow valve 130 slightly; and if the user wishes to infuse the food item 5 quicker, the flow valve 130 can be opened further.

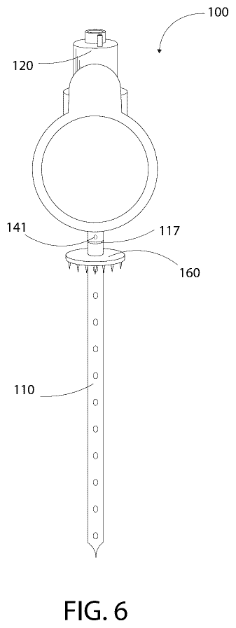

As shown in FIGS. 3-6, the device 100 may further comprise a vent assembly 140. In particular, the vent assembly 140 may include an air vent port 141 and an air vent line 142 attached at an air vent line first end 143 to the air vent port 141 and extending through an aperture 125 in the receptacle attachment element 120. In some embodiments, as shown in FIGS. 3-5, the air vent port 141 may be disposed between the receptacle attachment element 120 and the flow valve 130. For example, the air vent port 141 may be disposed within a collar attached to the flow valve 130. In other embodiments, as demonstrated in FIG. 6, the air vent port 141 may be disposed within the infuser conduit 110.

As shown in FIG. 3, the air vent line 142 may be configured for insertion into the receptacle 10 when the receptacle attachment element 120 is attached to the receptacle 10 and gases (i.e., air) from inside the receptacle 10 may be carried through the air vent line 142, from the air vent line second end 144 to the air vent line first end 143 for release via the air vent port 141. Thereby the vent assembly 140 prevents excess pressure build up from inside the receptacle 10, as well as preventing a vacuum from forming inside the receptacle 10.

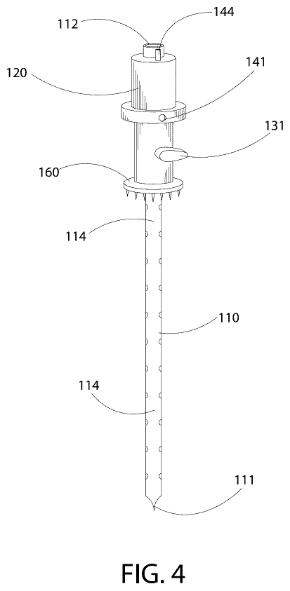

Further, in some embodiments, the device 100 may comprise a stabilizing ring 160. As best shown in FIG. 4, the stabilizing ring 160 may include a central opening 161 for receiving the infuser conduit 110 therethrough, and a plurality of downwardly extending spikes 162 for piercing through the food item 5, thereby holding the device 100 and the receptacle 10 vertical above the food item 5. In embodiments wherein the air vent port 141 is disposed within the infuser conduit 110, as shown in FIG. 6, the infuser conduit 110 may include a ridge 117 located below the air vent port 141. The ridge 117 may act as a stopper, preventing the infuser conduit 110 from moving further into the food item 5 and thereby keeping the air vent port 141 above the food item 5.

When the food item 5 has been infused for a desired period of time, the infuser conduit 110 may be removed from the food item 5. The device 100 may then be washed and reused when desired.

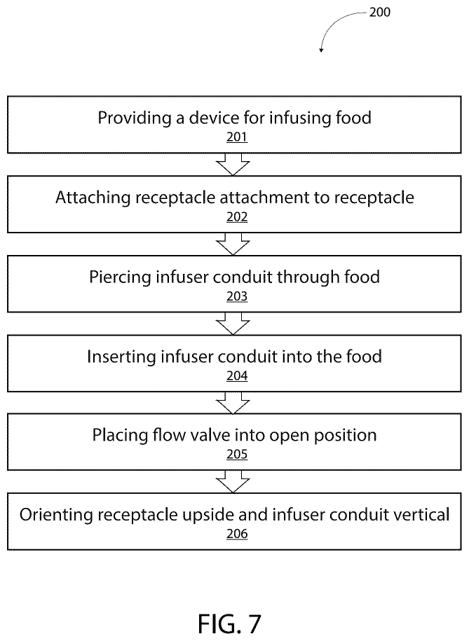

Referring now to FIG. 7 showing a flow diagram illustrating a method 200 of infusing a food item with a substance, according to an embodiment of the present disclosure. In particular, the method 200 may include one or more components or features of the device 100 as described above. As illustrated, the method 200 may include the steps of: step one 201, providing the device as above; step two 202, with the flow valve in a closed position, attaching the receptacle attachment element to an opening of a receptacle containing the substance; step three 203, piercing a first end of the infuser conduit through the food item; step four 204, inserting the length of the infuser conduit into the food item; and step five 205, placing the flow valve into an open position, thereby enabling the substance to flow from the receptacle, through the infuser conduit and out through the plurality of infusion holes to infuse the food item with the substance. A further step may include orienting 206 the receptacle in an inverted position and the infuser conduit vertically to allow the substance to flow via gravity.

It should be noted that certain steps can be optional and may not be implemented in all cases. It should also be noted that the steps described in the method 200 can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

1. A device for infusing a food item with a substance, the device comprising:
an infuser conduit having a first end opposite a second end, a length therebetween, and at least one infusion hole disposed on the length, the first end configured to pierce the food item for insertion of the at least one infusion hole into the food item;
a receptacle attachment element including a central bore disposed from a top to a bottom thereof through which the second end of the infuser conduit extends, the receptacle attachment element configured to attach to an opening of a receptacle containing the substance, thereby placing the infuser conduit in fluid communication therewith; and
a flow valve attached along the length of the infuser conduit below the receptacle attachment element, the flow valve configured to control flow of the substance through the infuser conduit.

2. The device of claim 1, further comprising a vent assembly for preventing excess pressure build up inside the receptacle, wherein the vent assembly includes an air vent port and an air vent line attached at an air vent line first end to the air vent port and extending through the receptacle attachment element, the air vent line configured for insertion into the receptacle when the receptacle attachment element is attached to the receptacle.

3. The device of claim 1, wherein the receptacle is oriented in an inverted position and the infuser conduit is oriented vertically when inserted into the food item, thereby allowing the substance to flow from the receptacle, through the infuser conduit and into the food item via gravity.

4. The device of claim 1, wherein the infuser conduit includes a plurality of infusion holes disposed on the length thereof.

5. The device of claim 1, further comprising a stabilizing ring including a central opening for receiving the infuser conduit therethrough, and a plurality of downwardly extending spikes configured to insert into the food item.

6. The device of claim 1, wherein the receptacle attachment element includes a cylindrical configuration sized for insertion into the opening of the receptacle.

7. The device of claim 6, wherein the receptacle attachment element is a cork.

8. The device of claim 6, wherein the receptacle attachment element is constructed from rubber.

9. The device of claim 1, wherein the substance is a flavoring.

10. The device of claim 1, wherein the substance is alcohol.

11. A device for infusing a watermelon with a substance, the device comprising:
an infuser conduit having a first end opposite a second end, a length therebetween, and a plurality of infusion holes disposed along at least a substantial portion of the length, the first end configured to pierce the watermelon for insertion of the plurality of infusion holes into the watermelon;
a receptacle attachment element including a central bore disposed from a top to a bottom thereof through which the second end of the infuser conduit extends, the receptacle attachment element configured to attach to an opening of a receptacle containing the substance, thereby placing the infuser conduit in fluid communication therewith;
a flow valve attached along the length of the infuser conduit below the receptacle attachment element, the flow valve configured to control flow of the substance through the infuser conduit; and
a vent assembly including an air vent port and an air vent line attached at an air vent line first end to the air vent port and extending through the receptacle attachment element, the air vent line configured for insertion into the receptacle when the receptacle attachment element is attached to the receptacle.

12. The device of claim 11, wherein the receptacle is oriented in an inverted position and the infuser conduit is oriented vertically when inserted into the watermelon, thereby allowing the substance to flow from the receptacle, through the infuser conduit and into the watermelon via gravity.

13. The device of claim 11, further comprising a stabilizing ring including a central opening for receiving the infuser conduit therethrough, and a plurality of downwardly extending spikes configured to insert into the food item.

14. The device of claim 11, wherein the receptacle attachment element includes a cylindrical configuration sized for insertion into the opening of the receptacle.

15. The device of claim 14, wherein the receptacle attachment element is a cork.

16. The device of claim 14, wherein the receptacle attachment element is constructed from rubber.

17. The device of claim 11, wherein the substance is a flavoring.

18. The device of claim 11, wherein the substance is alcohol.

19. A method of infusing a food item with a substance, the method comprising the steps of:
providing a device having an infuser conduit including a plurality of infusion holes along a length thereof, a receptacle attachment element including a central bore through which the infuser conduit extends, and a flow valve in communication with the infuser conduit;
with the flow valve in a closed position, attaching the receptacle attachment element to an opening of a receptacle containing the substance;
piercing a first end of the infuser conduit through the food item;
inserting the length of the infuser conduit into the food item; and
placing the flow valve into an open position, thereby enabling the substance to flow from the receptacle, through the infuser conduit and out through the plurality of infusion holes to infuse the food item with the substance.

20. The method of claim 19, further comprising the step of: orienting the receptacle in an inverted position and the infuser conduit vertically to allow the substance to flow via gravity into the food item.
